(19) United States
(12) Patent Application Publication
(10) Pub. No.: US 2005/0141182 A1
(43) Pub. Date: Jun. 30, 2005

(54) Image picking device

(76) Inventors: Tian-Shun Ma, Taipei (TW); Chien-Cheng Huang, Taipei (TW)

Correspondence Address: G. LINK CO., LTD, 3550 Bell Road, Minooka, IL, 60447, US

(21) Appl. No.: 10/747,481

(22) Filed: Dec. 25, 2003

(51) Int. Cl. G06F 1/16

(52) U.S. Cl. 361/683

(57) ABSTRACT

An image picking device includes a casing, a picking unit received in the casing, at least one arm pivotally connected to the casing and a cover pivotally connected to the casing and can be moved to abut the casing. The at least one arm and the cover can stand the image picking device on a supporting surface and fixed the image picking device to a panel when the at least one arm is buckled on a top of the panel and the cover abuts the back of the panel.

### BACKGROUND OF THE INVENTION

1. Field of the Invention

The present invention relates to an image picking device, and more particularly to an image picking device that can be fixed on an object or stand on a supporting surface.

2. Description of Related Art

An image picking device is widely used in a net-meeting, a monitor system or combined with a personal computer (PC) to record the personal image into the PC or transmit to the internet for sharing with his/her friends. The image picking device not only records a movement video but also takes a static picture for satisfying the purposes of the user.

According to the shape of the image picking device, there are two types, such as ethereal style or like a digital camera. The ethereal style usually stands on a supporting surface or clamps to an object, such as a thin PC monitor.

With reference to FIG. 1, a conventional image picking device (10) in accordance with the prior art comprises a fastener (11) for fixing the conventional image picking device on a display panel (1). The fastener (11) includes an L-shaped base member (112) clamped to the display panel (1) and a resilient element (not shown) located between the back of the display panel (1) and the base member (112) to hold the base member (112) in place on the display panel (1). A seat (111) upwardly extends from base member (112) and the image picking device (10) is secured on the seat (111).

However, the above structure cannot stably stand the image picking device on a supporting surface, such as a desktop so that the use scope of the conventional image picking device is limited. The angle and the direction of finding a view are very important to an image picking device. The conventional image picking device cannot universally picking image. For protecting the lens of the conventional image picking device, a separated cap is attached to the lens after using. To carry the extra cap is very inconvenient.

The present invention has arisen to mitigate and/or obviate the disadvantages of the conventional image picking device.

### SUMMARY OF THE INVENTION

A main object of the present invention is to provide an improved image picking device that can be fixed on an object or stand on a supporting surface.

To achieve the objective, the image picking device in accordance with the present invention comprises a casing, a picking unit received in the casing, at least one arm pivotally connected to the casing and a cover pivotally connected to the casing and can be moved to abut the casing. The at least one arm and the cover can stand the image picking device on a supporting surface and fixed the image picking device to a panel when the at least one arm is buckled on a top of the panel and the cover abuts the back of the panel.

Further benefits and advantages of the present invention will become apparent after a careful reading of the detailed description with appropriate reference to the accompanying drawings.

### BRIEF DESCRIPTION OF THE DRAWINGS

FIG. 1 is a perspective schematic view of a conventional image picking device in accordance with the prior art;

FIG. 2 is a perspective view of an image picking device in accordance with the present invention;

FIG. 3 is an exploded perspective of the image picking device in FIG. 2;

FIG. 4 is an operational side plan view of the image picking device in FIG. 2;

FIG. 5 is an operational top plan view of the image picking device in FIG. 2;

FIG. 6 is a side schematic plan view of the image picking device in FIG. 2 when standing on a supporting surface; and

FIG. 7 is a side schematic plan view of the image picking device in FIG. 2 after being folded.

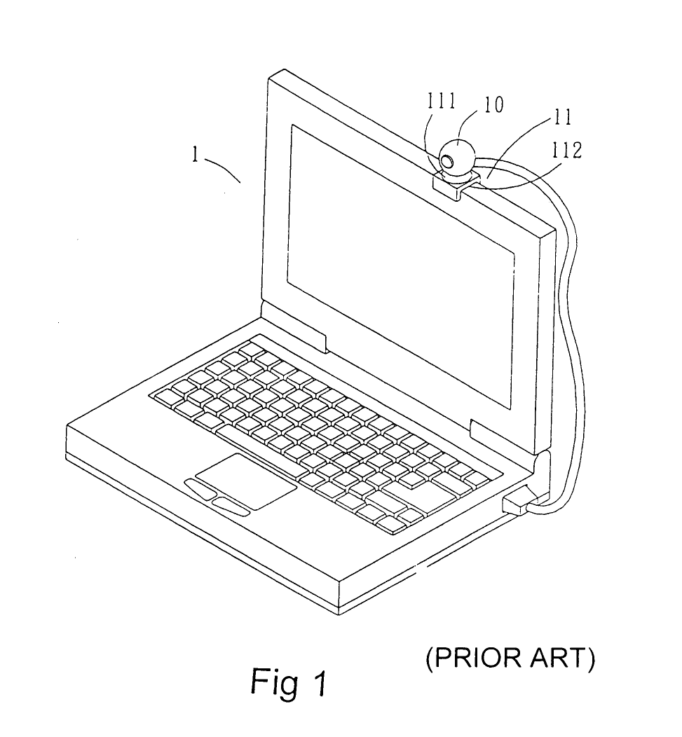

### DETAILED DESCRIPTION OF THE PREFERRED EMBODIMENT

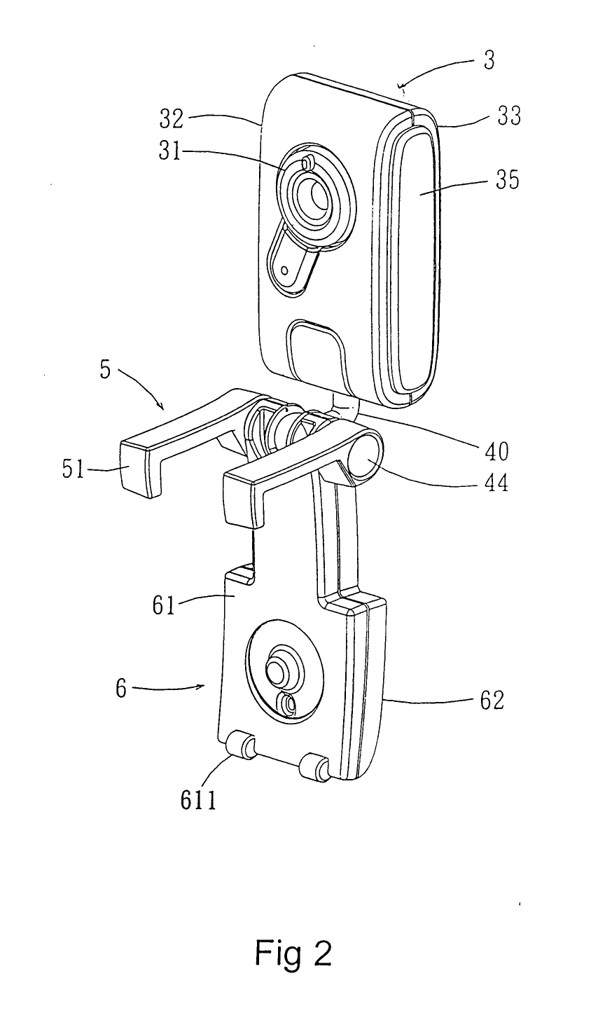

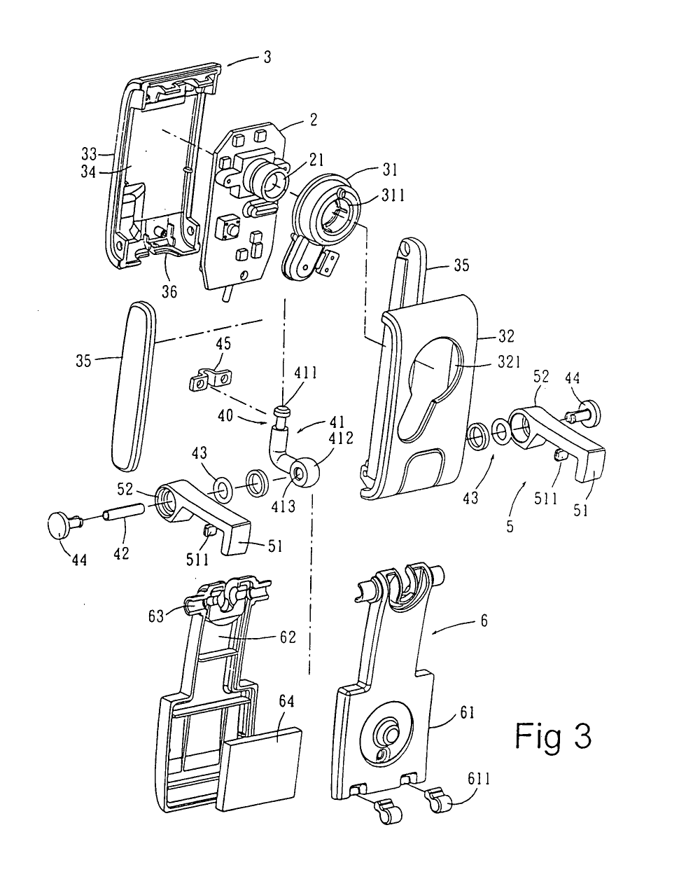

With reference to the drawings and initially to FIGS. 2 and 3, an image picking device in accordance with the present invention comprises a casing (3), a picking unit (2) received in the casing (3) and at least one arm (5) pivotally connected to the casing (3). The picking unit (2) includes lens (21) with a picking function.

The casing (3) includes a sleeve (31) received therein and mounted around the lens (21) to hold the picking unit (2) in place in the casing (3). The casing (3) includes a first portion (32) and a second portion (33) abutting each other to define a receiving space (34) for receiving the picking unit (2). The sleeve (31) partially extends through the first portion (32) of the casing (3). Two connectors (35) are respectively attached to two opposite sides of the casing (3) to promote the connection between the first portion (32) and the second portion (34) of the casing (3). A through hole (36) is defined in a bottom of the second portion (33). The hole (311) is defined in and extending through the sleeve (31) for receiving and protecting the lens (21) of the picking unit (2). An opening (321) is defined in the first portion (32) of the casing (3) and the sleeve (31) partially extends through the opening (321) and secured within opening (321).

A pivot unit (40) is pivotally mounted to the bottom of the casing (3). The pivot unit (40) includes an L-shaped shaft (41). The L-shaped shaft (41) has a first end (411) extending into the casing (3) via the through hole (36) in the casing (3) The L-shaped shaft (41) has a connecting portion (412) formed on a second end thereof. The connecting portion (412) has a through hole (413) laterally defined therein. A pin (42) extends through the through hole (413) in the connecting portion (412) of the L-shaped shaft (41). Multiple washers (43) mounted around the pin (42) and two end pieces (44) respectively attached to two opposite ends of the pin (42) for reducing the friction between the connecting portion (412) and the arms (5). A locking member (45) is mounted to the first end (411) of the L-shaped shaft (41) and secured on the picking unit (2) to prevent the L-shaped shaft (41) from detaching from the casing (3). A cover (6) is pivotally connected to the connecting portion (412) of the L-shaped shaft (41).

In the preferred embodiment of the present invention, the number of the arm (5) is two. The two arms (5) respectively pivotally mounted to two opposite ends of the pin (42). Each arm (5) includes a clamp (51) extending from a first end thereof and a pivot portion (52) formed on a second end thereof. Each end piece (44) of the pivot unit (40) is partially received in a corresponding one of the two arms (5) to prevent the arm (5) from detaching from the pivot unit (40). Each arm (5) has a stopper (511) downward extending therefrom near a middle portion thereof.

The cover (6) includes a front portion (61) corresponding to the sleeve (31) and a rear portion (62) securely abutting to the front portion (61). The front portion (61) and the rear portion (62) each has a groove (63) defined in a top portion thereof for pivotally receiving the pin (42). At least one protrusion (611) mounted to a lower side of the front portion (61) of the cover (6). The cover (6) has an inverted T-shape so that the two arms (5) can be folded to the two opposite sides of the cover (6) for reducing the volume of the present invention during stored. The cover (6) further includes a heavier (64) received therein.

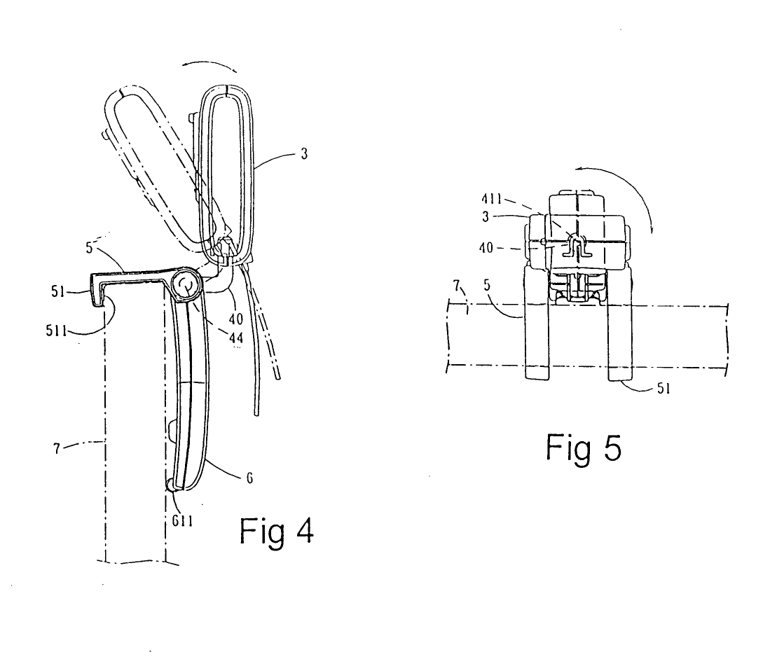

With reference to FIGS. 4 and 5, the cover (6) extends relative to the casing (3) and is mounted on a top of the display panel (7). When operating the image picking device in accordance with the present invention, the clamp (51) is buckled on a front edge of the display panel (7), the cover (6) abuts the back of the display panel (6) and the casing (3) upwardly stands on the top of the display panel (7). The gravity of the is cover (6) is downward moved due to the heavier (64) so that cover (6) can stably abut the back of the display panel (7). The stopper (511) can promote the connection between the arm (5) and the top of the display panel (7). The casing (3) can be upwardly and downward moved relative to a horizontal due to the connecting portion (412) and can be rotated relative to an axis of the L-shape shaft (41) due to the pivoted first end (411) of the L-shaped shaft (41). Consequently, the casing (3) with the picking unit (2) can be universally adjusted during operating.

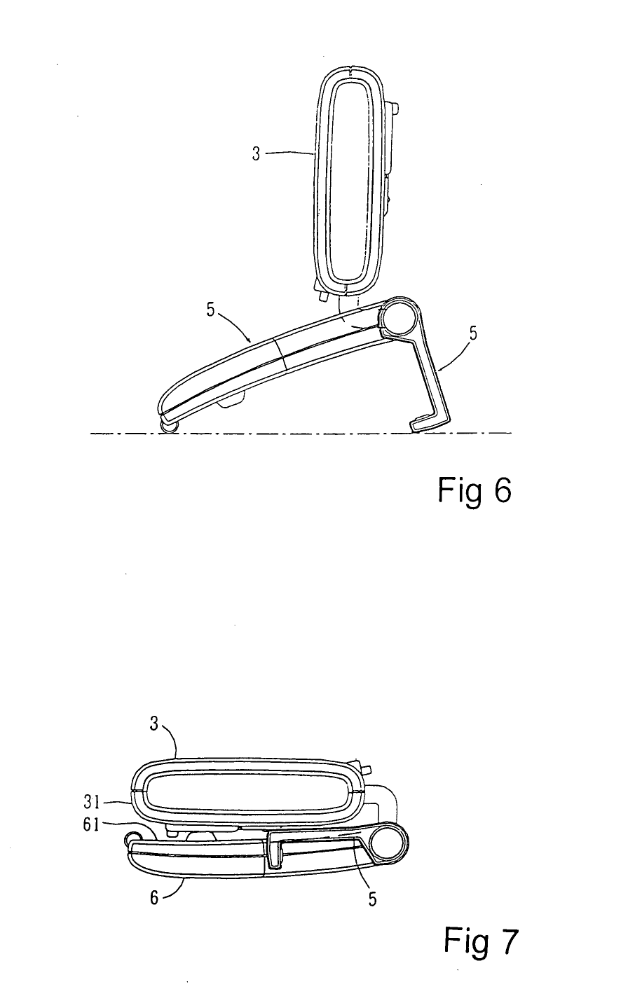

With reference to FIG. 6, the casing (3) with the picking unit (2) can stably stand on a supporting surface, such as a desktop, a mainframe of PC, due to the cover (6) and the two arms (5).

With reference to FIG. 7, when folding the image picking device in accordance with the present invention, the two arms (5) is moved to the two opposite sides of the cover (6) and the cover is moved to abut the first portion (32) of the casing (3) for protecting the picking unit (2).

As described above, the image picking device in accordance with the present invention comprises a picking unit (2), a casing (3) for receiving the picking unit (2), two arms (5) respectively pivotally mounted to two opposite sides of the casing (3) and a cover (6) pivotally connected to the casing (3). The image picking device of the present invention can stand on a supporting surface or fixed on a display panel of a PC so that it is more convenient than the conventional image picking device in operation. Furthermore, the caver (6) of the present invention can provide a protection to the lens (21) of the picking unit (2) when the cover (6) is moved to abut the casing (3).

Although the invention has been explained in relation to its preferred embodiment, it is to be understood that many other possible modifications and variations can be made without departing from the spirit and scope of the invention as hereinafter claimed.

1. An image picking device comprising:
a casing;
a picking unit received in the casing;
at least one arm, being pivotally connected to the casing; and
a cover, being pivotally connected to the casing and being able to moved to abut the casing;
whereby, the arm and the cover can stand the image picking device on a supporting surface and fixed the image picking device to a panel when the at least one arm is buckled on a top of the panel and the cover abuts the back of the panel.

2. The image picking device as defined in claim 1, further comprises two arms.

3. The image picking device as defined in claim 1 further comprising a pivot unit pivotally mounted to a bottom of the casing, the pivot unit including an L-shaped shaft having a first end pivotally extending into the casing and a connecting portion formed on a second end thereof, the connecting portion having a through hole laterally defined therein and a pin extending through the through hole, the cover pivotally connected to the connecting portion of the L-shaped shaft.

4. The image picking device as defined in claim 3, wherein the two arms are respectively pivotally mounted to two opposite ends of the pin, each arm including a clamp extending from a first end thereof for buckling on the panel and a pivot portion formed on a second end thereof, the pin extending through the pivot portion of each of the two arms.

5. The image picking device as defined in claim 3, wherein the pivot unit comprises two end pieces respectively attached to the two opposite ends of the pin to prevent the arm from detaching from the pin.

6. The image picking device as defined in claim 3, wherein the pivot unit comprises multiple washers mounted around the pin for reducing the friction between the connecting portion and the arms.

7. The image picking device as defined in claim 1, wherein the cover comprises a heavier received therein for downward moving a gravity of the cover.

8. The image picking device as defined in claim 1, wherein each arm comprises a stopper downward extending therefrom near a middle portion thereof and the cover has at least one protrusion mounted to a lower side of the cover for promoting a connection among the arm, the caver and the panel.

9. The image picking device as defined in claim 1, wherein the panel is a display panel of a personal computer.
